(19) United States
(12) Patent Application Publication
(10) Pub. No.: US 2026/0208774 A1
(43) Pub. Date: Jul. 23, 2026

(54) ABNORMAL OBJECT DETECTION WARNING SYSTEM AND ABNORMAL OBJECT DETECTION METHOD

(71) Applicant: Wistron Corporation, New Taipei City (TW)

(72) Inventors: Zhe Yu LIN, New Taipei City (TW); Zhao Yuan LIN, New Taipei City (TW); Cheng Yang CHEN, New Taipei City (TW)

(21) Appl. No.: 19/185,629

(22) Filed: Apr. 22, 2025

(30) Foreign Application Priority Data
Jan. 23, 2025 (TW) 114103241

(51) Int. Cl. B61L 23/04; G06T 7/11; G06T 7/13; G06T 7/194; G06V 10/25

(52) U.S. Cl. CPC B61L 23/044; B61L 23/041; G06T 7/11; G06T 7/13; G06T 7/194; G06V 10/25; G06T 2207/20084; G06V 2201/07

(57) ABSTRACT

An abnormal object detection warning system applicable to an unmanned vehicle performing a track inspection task includes a storage module, a detection module, and a notification module. An abnormal object detection method, including: storing image data captured by an unmanned vehicle; detecting the image data to identify image data with abnormal characteristics from the image data; and transmitting the image data with the abnormal characteristics to a mobile device of a user. An electronic device has a system software including an abnormal object detection warning system, and the system software can be updated online.

### CROSS-REFERENCE TO RELATED APPLICATION

This non-provisional application claims priority under 35 U.S.C. § 119(a) to Patent Application No. 114103241 filed in Taiwan, R.O.C. on Jan. 23, 2025, the entire contents of which are hereby incorporated by reference.

### BACKGROUND

### Technical Field

The present disclosure relates to an abnormal object detection warning system and an abnormal object detection method, and in particular to an abnormal object detection warning system and an abnormal object detection method applicable to neural network to detect foreign objects on bent rails and railways.

### Related Art

Many public transports in modern city today include railways systems, such as MRT, Metro or LRT. Some of these railways are built aboveground, some are underground or in tunnels, or some are in the air. Due to the advantages of high speed and high volume of railway transport in transporting passengers, the safety of the railway systems is very important, especially the safety of railways and rails. At present, it is known that MRT operation agency will send some staff to perform anomaly inspection in MRT tunnels in the late night after the end of operation each day. In addition, post-disaster inspections are also required after natural disasters (e.g. earthquakes, typhoons) to check the current damage status of tunnels and determine whether to resume operations, which will result in a lot of additional manpower requirements.

Traditional inspections require many staff to walk around each section of the tunnel to inspect, and most of the inspection time is at night, and overtime costs are high. If unmanned vehicles (e.g., unmanned aerial vehicles, and aerial cameras) are used for inspection, it is relatively cost-effective, but in a tunnel with dim lighting, and it is a challenge for the unmanned vehicles to identify the environment in the tunnel and fly safely, and to take identifiable photos. In this case, it is needed to overcome the technical challenges of ensuring that the unmanned vehicles could accurately identify any anomalies in the tunnel, while flying safely and stably in narrow spaces of the tunnel.

Unmanned vehicles equipped with cameras are used for entering the MRT underground tunnel for inspection, and the captured images combined with artificial intelligence technology are used for automatically detecting anomalies in the tunnel, so as to reduce a lot of manpower for daily inspection and improve the speed of resumed MRT after the disaster. The items to be inspected include whether there are any objects left behind or dropped on the tunnel and rails (e.g., maintenance tools dropped or not removed, lamps, tunnel rings and cement block dropped), and whether the rails are abnormally bent to affect the safety of trains in running.

### SUMMARY

An embodiment of the present disclosure provides an abnormal object detection warning system being applicable to an unmanned vehicle to perform a track inspection task, and including a storage module, a detection module and a notification module; the storage module is configured to store image data captured by an unmanned vehicle; the detection module is configured to detect the image data to identify image data with abnormal characteristics from the image data; and the notification module is configured to transmit a warning signal of the image data with the abnormal characteristics. For example, the warning signal is transmitted to a mobile device of a user (such as staff). In addition, the notification module can also transmit the image data with the abnormal characteristics to the user.

An embodiment of the present disclosure provides an abnormal object detection method, including: storing image data captured by an unmanned vehicle through a storage module; detecting the image data to identify image data with abnormal characteristics from the image data; and transmitting the image data with the abnormal characteristics to a mobile device of a user.

An embodiment of the present disclosure provides an electronic device, including a storage unit, a memory unit and a network unit; the storage unit is configured to store image data captured by an unmanned vehicle; the memory unit is configured to store system software for the electronic device to execute; and the network unit is configured to transmit image data with abnormal characteristics, where the electronic device updates the system software online through the network unit.

An embodiment of the present disclosure provides system software, including a detection module; the detection module is configured to detect image data to identify image data with abnormal characteristics from the image data; the detection module includes a neural network module, and the neural network module is configured to receive the image data and process the image data through a neural network so as to obtain a prediction output; and the detection module generates a mark on the image data with the abnormal characteristics based on the prediction output.

### BRIEF DESCRIPTION OF THE DRAWINGS

FIG. 1 is a schematic diagram of an Embodiment I of an abnormal object detection warning system according to an embodiment of the present disclosure.

FIG. 2 is a block diagram of an Embodiment II of an abnormal object detection warning system according to an embodiment of the present disclosure.

FIG. 3 is a block diagram of an Embodiment III of an abnormal object detection warning system according to an embodiment of the present disclosure.

FIG. 4 is a flowchart of an abnormal object detection method according to an embodiment of the present disclosure.

FIG. 5 is a block diagram of an Embodiment I of a detection module of an abnormal object detection warning system according to an embodiment of the present disclosure.

FIG. 6 is a flowchart of an Embodiment I of an abnormal object detection method according to an embodiment of the present disclosure.

FIG. 7 is a block diagram of a neural network architecture of an object detection module according to an embodiment of the present disclosure.

FIG. 8 is a schematic diagram of a rail boundary after processing by a rail boundary processing module according to an embodiment of the present disclosure.

FIG. 9 is a schematic diagram of a section slope after processing by a linear regression processing module according to an embodiment of the present disclosure.

FIG. 10 is a block diagram of an Embodiment II of a detection module of an abnormal object detection warning system according to an embodiment of the present disclosure.

FIG. 11 is a flowchart of an Embodiment II of an abnormal object detection method according to an embodiment of the present disclosure.

FIG. 12 is a schematic diagram of a region-of-interest extraction module according to an embodiment of the present disclosure.

FIG. 13 is a schematic diagram of an anomaly detection module according to an embodiment of the present disclosure.

FIG. 14 is a schematic diagram of abnormal characteristics detected by an anomaly detection module according to an embodiment of the present disclosure.

FIG. 15 is a schematic diagram of marks of abnormal characteristics according to an embodiment of the present disclosure.

### DETAILED DESCRIPTION

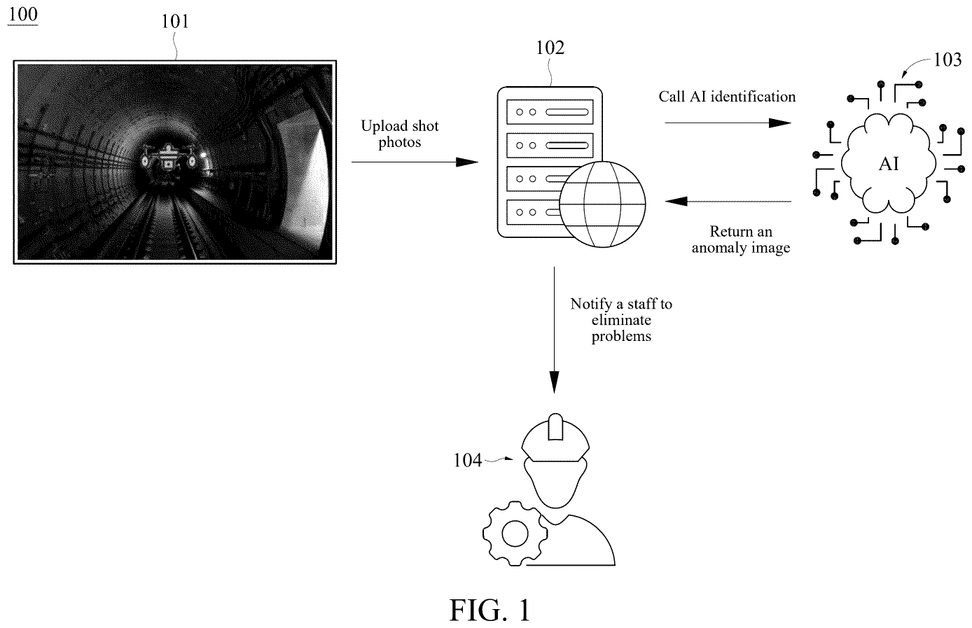

Please refer to FIG. 1, FIG. 1 is a schematic diagram of an Embodiment I of an abnormal object detection warning system 100 according to an embodiment of the present disclosure. As shown in FIG. 1, an unmanned vehicle will carry a camera and a lighting lamp to perform railway inspection tasks, automatically shoot along a rail according to an inspection time schedule, automatically fly to a base station for charging after inspection, and upload shot photos 101 to a server 102 while charging. In an MRT tunnel with dim light, the unmanned vehicle can provide a lighting source through the lighting lamp to identify the environment for flying safely, and shoot the identifiable photos 101. The server 102 can include a remote server or a cloud server connected through a network. The unmanned vehicle can upload the shot photos 101 to the server 102, and the server 102 receives the photos 101 in a wired or wireless manner through a communication connection port (such as a serial port, a parallel port, a USB port or a network port), and stores the photos 101 in a storage unit (such as a hard disk) through a storage instruction. At the moment, the abnormal object detection warning system 100 automatically starts an AI image identification service 103 to identify the photos 101 so as to find out abnormal characteristics in the photos 101, and then the AI image identification service 103 returns the photos 101 with the abnormal characteristics, and mark positions of the abnormal characteristics on the photos 101 with the abnormal characteristics. The AI image identification service 103 can include an artificial intelligence module having a neural network, and The AI image identification service 103 can find out the abnormal characteristics in the photos 101 through operation of a central processing unit or a graphic processor of the server 102. The abnormal characteristics can include a bent rail and foreign objects on a railway. After receiving the returned photos 101 with the abnormal characteristics from the AI image identification service 103, the abnormal object detection warning system 100 will automatically transmit a warning signal of the photos 101 with the abnormal characteristics through a communication system or a network system, or transmit the photos 101 with the abnormal characteristics to a mobile device equipped by staff 104, and notify the staff 104 to check a field to eliminate problems.

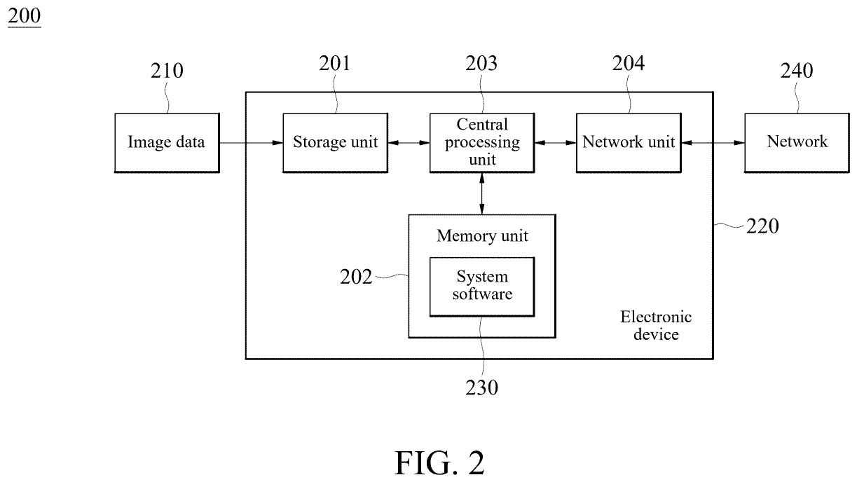

Please refer to FIG. 2, FIG. 2 is a block diagram of an Embodiment II of an abnormal object detection warning system 200 according to an embodiment of the present disclosure. As shown in FIG. 2, the abnormal object detection warning system 200 is applicable to image data 210 captured by an unmanned vehicle performing an inspection track task. The abnormal object detection warning system 200 includes an electronic device 220, and the electronic device 220 can be one of a group consisting of an embedded system, an intelligent mobile device, the unmanned vehicle, a personal computer, a server and a cloud server. The electronic device 220 can receive the image data 210 (such as photos or films), and store the image data 210 to a storage unit 201 (such as a hard disk). The electronic device 220 of the abnormal object detection warning system 200 includes system software 230. The system software 230 is stored in a memory unit 202 (such as a flash memory). Optionally, the system software 230 can also be stored in the storage unit 201. A central processing unit 203 (such as a central processor) can execute the system software 230 to perform image identification on the image data 210 so as to find out abnormal characteristics in the image data 210. In addition, in order to improve the accuracy of determining the abnormal characteristics by the abnormal object detection warning system 200, the electronic device 220 can be connected to a network 240 through a network unit 204 to perform online updating on the system software 230. Through an online updating mechanism, the abnormal object detection warning system 200 can obtain the system software 230 of the latest version, so that the accuracy of image identification is improved.

In one embodiment, the system software 230 can include a detection module 302, the detection module 302 can include a neural network module 304, the neural network module 304 is configured to receive the image data 210, and the image data 210 is processed through a neural network so as to obtain a prediction output; and the detection module 302 generates a mark on the image data 210 with the abnormal characteristics.

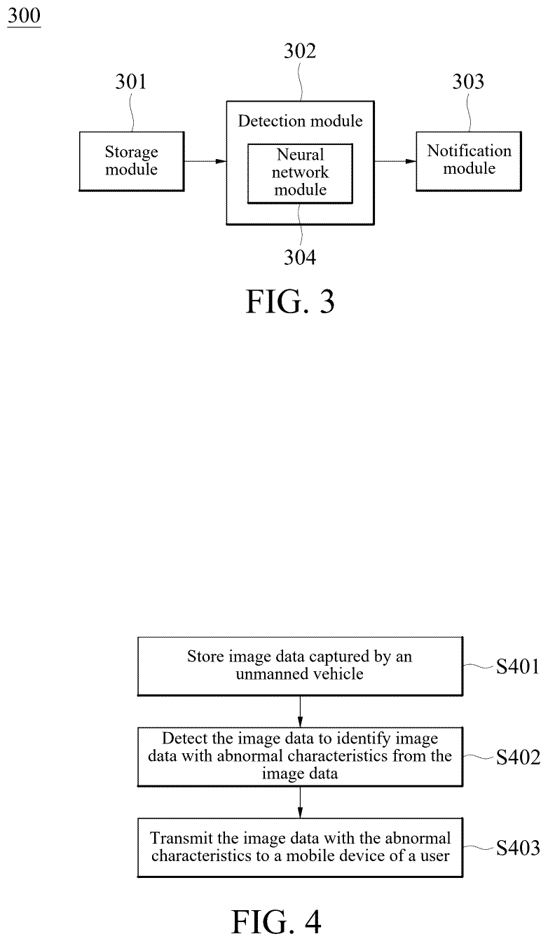

Please refer to FIG. 3, FIG. 3 is a block diagram of an Embodiment III of an abnormal object detection warning system 300 according to an embodiment of the present disclosure. As shown in FIG. 3, the abnormal object detection warning system 300 is applicable to an unmanned vehicle performing a track inspection task. The abnormal object detection warning system 300 includes: a storage module 301, a detection module 302 and a notification module 303. The storage module 301 is configured to store image data 210 captured by an unmanned vehicle. The detection module 302 is configured to detect the image data 210 to identify image data 210 with abnormal characteristics from the image data 210. The detection module 302 includes a neural network module 304, the neural network module 304 is configured to receive the image data 210 and process the image data 210 through a neural network so as to obtain a prediction output; and the detection module 302 generates a mark on the image data 210 with the abnormal characteristics based on the prediction output. The notification module 303 is configured to transmit a warning signal of the image data 210 with the abnormal characteristics.

Please refer to FIG. 4, FIG. 4 is a flowchart of an abnormal object detection method according to an embodiment of the present disclosure. As shown in FIG. 4, the abnormal object detection method includes steps S401-S403. Step S401 includes: storing image data 210 captured by an unmanned vehicle through a storage module 301. Step S402 includes: detecting the image data 210 by a detection module 302 so as to identify image data 210 with abnormal characteristics from the image data 210. Step S403 includes: transmitting the image data 210 with the abnormal characteristics to a mobile device of a user through a notification module 303.

In one embodiment, by taking the unmanned vehicle (such as an unmanned aerial vehicle, and an aerial camera) as an example, the unmanned vehicle can store the image data 210 captured by the unmanned vehicle in a flash memory or a memory card through the storage module 301. The unmanned vehicle can perform real-time image identification on the image data 210 through the detection module 302 so as to identify the abnormal characteristics (such as a bent rail and foreign objects on the railway). In one embodiment, the unmanned vehicle can perform local operation, boundary operation or cloud operation on the image data 210 to achieve a purpose of identifying the abnormal characteristics in real time. In one embodiment, inspection tasks of a plurality of tracks can be performed at the same time through a plurality of unmanned vehicles, and data and computation tasks of the plurality of unmanned vehicles are shared through cooperative work of edge computing so as to accelerate the real-time image identification efficiency. In one embodiment, when the abnormal object detection warning system 300 finds that the image data 210 has the abnormal characteristics, the unmanned vehicle can notify or warn the user in real time through the notification module 303, including transmitting a warning signal of the image data 210 with the abnormal characteristics, or transmitting the image data 210 with the abnormal characteristics to the mobile device equipped by the user.

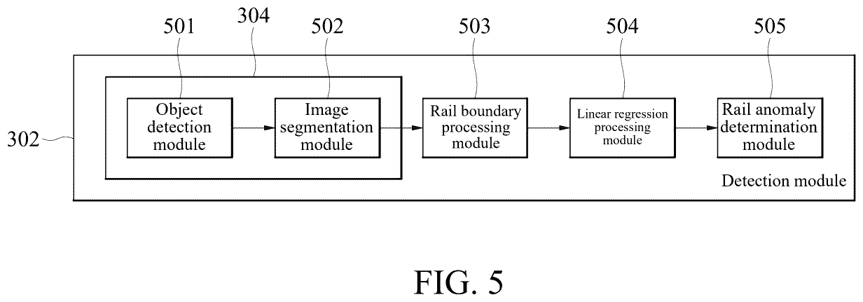

Please refer to FIG. 5, FIG. 5 is a block diagram of an Embodiment I of a detection module 302 of an abnormal object detection warning system 300 according to an embodiment of the present disclosure. As shown in FIG. 5, the detection module 302 includes an object detection module 501, an image segmentation module 502, a rail boundary processing module 503, a linear regression processing module 504, and a rail anomaly determination module 505.

The object detection module 501 is configured to detect a rail region in image data 210 so as to obtain a rail region image. The image segmentation module 502 is configured to remove a non-rail background image in the rail region image so as to obtain a rail boundary image. The rail boundary processing module 503 is configured to process the rail boundary image so as to obtain a rail boundary, and segment the rail boundary into a plurality of sections. The linear regression processing module 504 is configured to perform linear regression on each section in the plurality of sections so as to obtain a section slope of each section, and compute a mean slope of the plurality of sections. The rail anomaly determination module 505 is configured to compute a determination value based on the section slope and the mean slope, and determine whether the rail is bent according to the determination value.

In one embodiment, the detection module 302 includes the neural network module 304, and the neural network module 304 includes the object detection module 501. The object detection module 501 can be a neural network model for object detection, and common object detection models are YOLO, R-CNN and the like. In a preferred embodiment, the object detection module 501 is trained by YOLO V4, but is not limited to this model. The trained object detection module 501 is specially configured to capture a rail region in the image data 210 so as to obtain the rail region image. As the rail only occupies a part of the image data 210, in order to simplify image processing and reduce the influence of other objects except the rail, only the rail region image (a box 1201 shown in FIG. 12) in the image data 210 is captured. In one embodiment, a rail middle section image (a box 1202 shown in FIG. 12) can be further captured from the rail region image, and the rail middle section image clearly contains the rail and regions on two sides of the rail. In addition, the picture can be reduced by only capturing the rail middle section image, the resolution is greatly reduced compared with that of an original picture, and the computation amount in subsequent steps can also be greatly reduced.

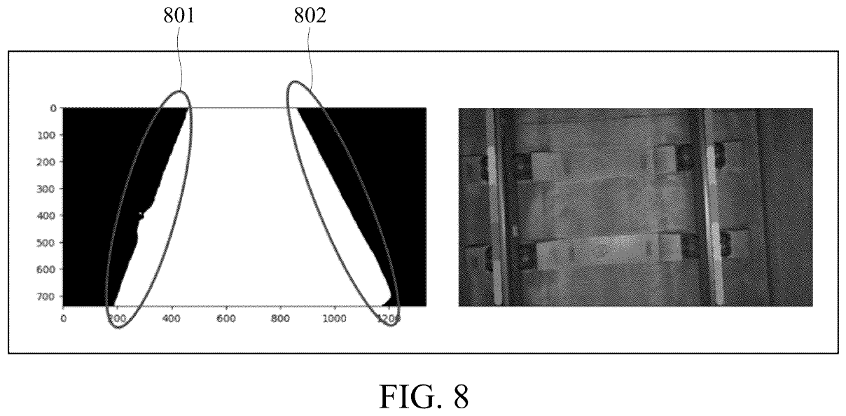

In one embodiment, the detection module 302 includes the neural network module 304, the neural network module 304 includes the image segmentation module 502, the image segmentation module 502 can be a neural network model configured to segment an image, such as UNET, and MASK R-CNN, and in a preferred embodiment, the image segmentation module 502 uses the UNET and is matched with EfficientnetB3 to serve as a backbone network. The trained image segmentation module 502 is specially configured to remove the non-rail background image. Because the rail region image obtained from the object detection module 501 still contains some unnecessary background images, the image segmentation module 502 can be configured to find out the position with the rail only, and remove the non-rail background image in the rail region image, so as to obtain the rail boundary image (as shown in FIG. 8).

In one embodiment, the rail boundary processing module 503 can process the rail boundary image so as to obtain the rail boundary. Because the left side and the right side of the rail boundary image obtained by the image segmentation module 502 are just the positions of the rail, the rail boundary processing module 503 can be configured to process the rail boundary image so as to obtain the rail boundaries on the left side and the right side (circled areas 801 and 802 in FIG. 8). If the rail is bent abnormally, the rail boundaries are certainly bent abnormally, and therefore whether the rail is abnormal can be determined according to whether the rail boundaries are bent. In addition, the rail boundary processing module 503 will segment the rail boundaries on the left side and the right side into a plurality of sections. In principle, the larger the number of the sections is, the higher the accuracy of determining whether the rail is bent is. Generally, the number of the sections can be evaluated according to the size of the images or the computing power of a hardware. In one preferred embodiment, the rail boundaries on the left side and the right side are each divided into 5 sections.

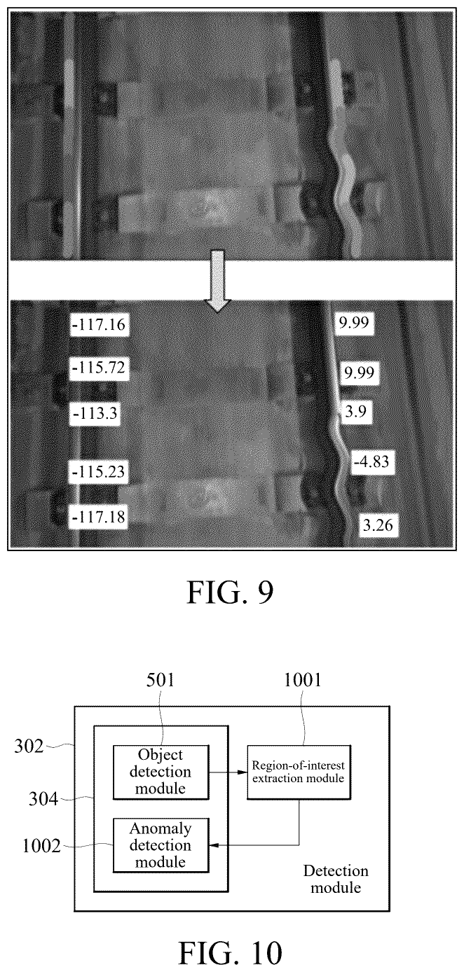

In one embodiment, the linear regression processing module 504 can perform linear regression on each section in the plurality of sections so as to obtain the section slope of each section, and compute the mean slope of the plurality of sections. That is, the linear regression processing module 504 can compute the slope of each section of the rail boundaries on the left side and the right side in a linear regression mode. The linear regression is to find out a linear equation from all points on the rail boundary of each section, and then the slope of each linear regression is computed in sequence (as shown in FIG. 9). Then, the mean slope of the plurality of sections of the rail boundaries on the left side and the right side is computed.

In one embodiment, the rail anomaly determination module 505 can compute the determination value based on the section slope and the mean slope, and determine whether the rail is bent according to the determination value. That is, the rail anomaly determination module 505 contains a formula for computing the determination value and a threshold value. When the determination value of one section exceeds a threshold value, it is determined that the image data 210 has the abnormal characteristics of abnormal bending of the rail, otherwise, the image data does not have the abnormal characteristics of abnormal bending of the rail. The threshold value is used for adjusting the determination strictness degree, the threshold value can be changed to adapt to different conditions, and in one preferred embodiment, the threshold value is 0.3. The formula of the determination value is as follows:

$$det\_value = \vert 1 - \frac{slop [ i ]}{m} \vert$$

where det_value represents the determination value; slop[i] represents the slope of the i^{th} section; and m represents the mean slope.

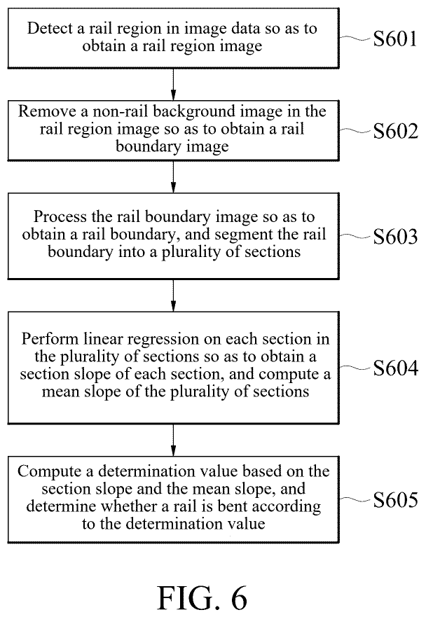

Please refer to FIG. 6, FIG. 6 is a flowchart of an Embodiment I of an abnormal object detection method according to an embodiment of the present disclosure. As shown in FIG. 6, the abnormal object detection method includes steps S601-S605. Step S601 includes: detecting a rail region in image data 210 by an object detection module 501 so as to obtain a rail region image. Step S602 includes: removing a non-rail background image in the rail region image by an image segmentation module 502 so as to obtain a rail boundary image. Step S603 includes: processing the rail boundary image by a rail boundary processing module 503 so as to obtain a rail boundary, and segmenting the rail boundary into a plurality of sections. Step S604 includes: performing linear regression on each section in the plurality of sections by a linear regression processing module 504 so as to obtain a section slope of each section, and computing a mean slope of the plurality of sections. Step S605 includes: computing a determination value based on the section slope and the mean slope by a rail anomaly determination module 505, and determining whether a rail is bent according to the determination value.

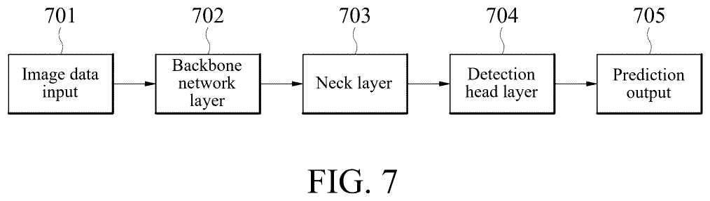

Please refer to FIG. 7, FIG. 7 is a block diagram of a neural network architecture of an object detection module 501 according to an embodiment of the present disclosure. As shown in FIG. 7, the neural network architecture of the object detection module 501 includes: an image data input 701, a backbone network layer 702, a neck layer 703, a detection head layer 704 and a prediction output 705. The image data input 701 is configured to provide image data 210 to the backbone network layer 702. The backbone network layer 702 is configured to extract a plurality of scale characteristics from the image data 210. The neck layer 703 is configured to combine the plurality of scale characteristics to improve abilities of detecting objects of various sizes. The detection head layer 704 is configured to predict bounding boxes and category of the objects based on the plurality of combined scale characteristics. The prediction output 705 is configured to obtain a prediction result of object classification.

In one embodiment, in one preferred embodiment, the object detection module 501 is YOLO V4 (You Only Look Once-version 4), YOLO V4 is an instant object detection technology for simultaneous object positioning and classification in a single network architecture, and due to the characteristics of high accuracy, high speed and easy training, it has a very wide range of applications, including: flaw detection in a manufacturing industry, monitoring systems for access control management and intelligent transportation, object identification of unmanned vehicles, and the like.

Please refer to FIG. 8, FIG. 8 is a schematic diagram of a rail boundary after processing by a rail boundary processing module 503 according to an embodiment of the present disclosure. In FIG. 8, the left is a schematic diagram of a left rail boundary and a right rail boundary (circled areas 801 and 802 in FIG. 8) processed by the rail boundary processing module 503. In addition, in FIG. 8, the right is a schematic diagram of a plurality of sections (such as 5 sections) segmented by the rail boundary processing module 503 from the left rail boundary and the right rail boundary.

Please refer to FIG. 9, FIG. 9 is a schematic diagram of a section slope after processing by a linear regression processing module 504 according to an embodiment of the present disclosure. FIG. 9 is a schematic diagram of the section slope of each section after processing by the linear regression processing module 504. In one embodiment, if the determination value of each section of the left rail boundary does not exceed the threshold value, it is determined that the left rail is normal; and if determination values of three sections below the right rail boundary exceed the threshold value, it is determined that the right rail is abnormally bent.

Please refer to FIG. 10, FIG. 10 is a block diagram of an Embodiment II of a detection module 302 of an abnormal object detection warning system 300 according to an embodiment of the present disclosure. As shown in FIG. 10, the detection module 302 includes the object detection module 501, a region-of-interest extraction module 1001 and an anomaly detection module 1002. The object detection module 501 is configured to detect the rail region in image data 210 so as to obtain the rail region image. The region-of-interest extraction module 1001 is configured to extract a rail middle section image from the rail region image. The anomaly detection module 1002 is configured to detect abnormal characteristics of the rail middle section image, and the abnormal characteristics contain foreign objects on the railway.

Please refer to FIG. 7 and FIG. 10, the object detection module 501 may be a neural network model used for object detection, and the trained object detection module 501 is specially configured to capture a rail region in the image data 210 so as to obtain the rail region image. In one embodiment, the backbone network layer 702 of the object detection module 501 is a cross stage partial darknet (CSPDarknet), the neck layer 703 is a combination of a spatial pyramid pooling (SPP) and a path aggregation network (PAN), and the detection head layer 704 is a YOLO Detection Head (YOLO-Head).

In one embodiment, the region-of-interest extraction module 1001 can extract the rail middle section image (a box 1202 shown in FIG. 12) from the rail region image (a box 1202 shown in FIG. 12). Because the unmanned vehicle (such as the aerial camera) has up-down and left-right space offset during flying, the railway position in each image data 210 cannot be fixed in the same region in the image data 210. If only the rail and regions on two side of the rail can be captured, the situation is simpler and more stable for subsequent foreign object detection. The rail and the regions on two side of the rail are the regions of interest (ROIs) of the region-of-interest extraction module 1001. The region-of-interest extraction module 1001 can extract the rail middle section image (the box 1202 shown in FIG. 12) from the rail region image (the box 1202 shown in FIG. 12). In one embodiment, the size of the image extracted by the region-of-interest extraction module 1001 can be adjusted according to the quality of the image data 210 captured by the unmanned vehicle, and the region of interest (ROI) takes the situation that the rail and the regions on two side of the rail can be clearly contained as a target. In one preferred embodiment, the size of the rail middle section image is about one half of the size of the rail region image.

Anomaly detection is an unsupervised technology and is suitable for situations with few anomaly data, normality data similar to the anomaly data and no anomaly data, so that the anomaly detection is very suitable for the field of automatic optical inspection (AOI) of factories. For the unsupervised anomaly detection, the anomaly is opposite to normality. Those not in training data are treated as anomaly, the anomaly detection can be used for detecting any type of anomaly whether it is seen or not. Although the anomaly detection cannot be influenced by the anomaly data, it is very sensitive to a background, and the background change of any point may cause unstable model prediction, which is regarded as abnormal characteristics, and therefore if each input is fixed in a certain stable range before the anomaly detection, the effect of the anomaly detection can be greatly improved. In one embodiment of the present disclosure, the object detection module 501 and the region-of-interest extraction module 1001 can be configured to capture the region-of-interest (ROI) in the image data 210.

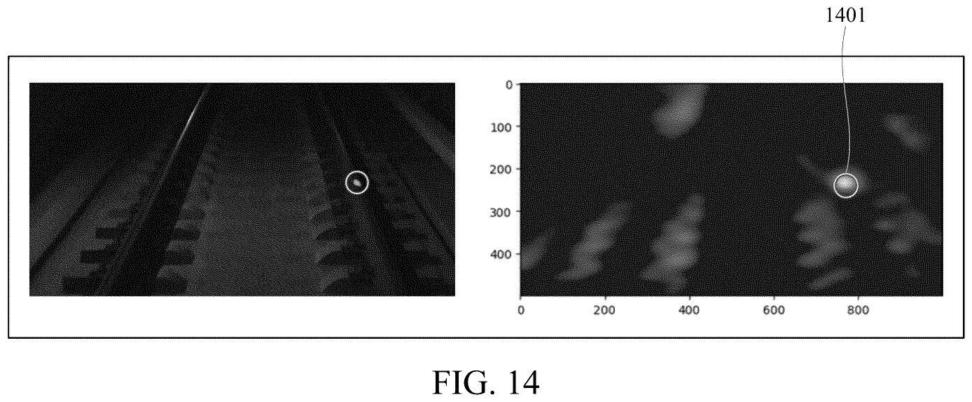

In one embodiment, the detection module 302 includes the neural network module 304, the neural network module 304 includes the anomaly detection module 1002, and the anomaly detection module 1002 can be a neural network model for anomaly detection. In a preferred embodiment, patch distribution modeling (PaDiM) is used, and a ResNet (Residual Network) is used as a backbone Network (such as ResNet18) to achieve easy and quick prediction. In addition, if it is needed to improve the prediction accuracy, other larger backbone networks can be replaced for retraining. The anomaly detection module 1002 takes the rail middle section image as the input, and thus the abnormal object (such as a circled area 1401 in FIG. 14) of the rail middle section image can be detected.

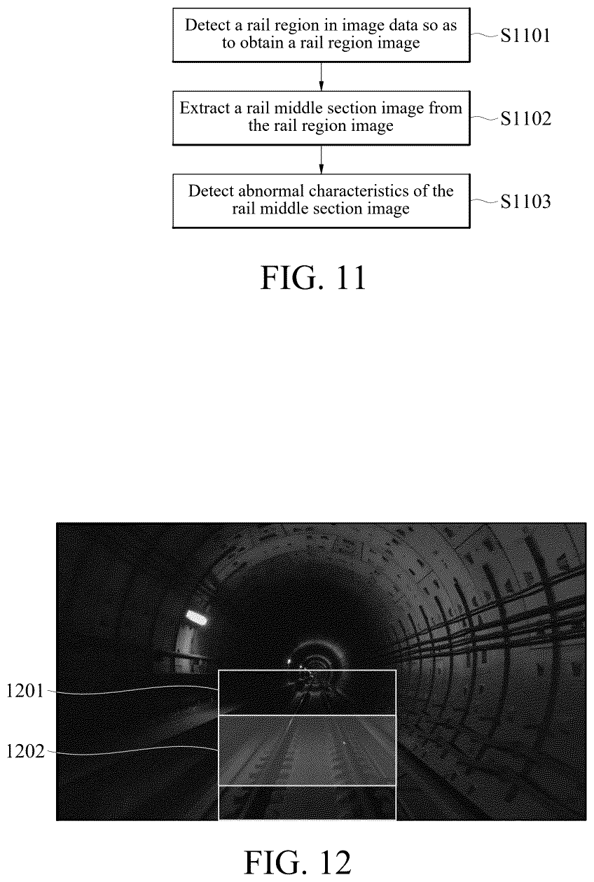

Please refer to FIG. 11, FIG. 11 is a flowchart of an Embodiment II of an abnormal object detection method according to an embodiment of the present disclosure. As shown in FIG. 11, the abnormal object detection method includes steps S1101-S1103. Step S1101 includes: detecting a rail region in image data 210 by an object detection module 501 so as to obtain a rail region image. Step S1102 includes: extracting a rail middle section image from the rail region image by a region-of-interest extraction module 1001. Step S1103 includes: detecting abnormal characteristics of the rail middle section image by an anomaly detection module 1002, where the anomaly detection module 1002 is the patch distribution modeling (PaDiM), and the abnormal characteristics includes foreign objects on the railway.

Please refer to FIG. 12, FIG. 12 is a schematic diagram of a region-of-interest extraction module 1001 according to an embodiment of the present disclosure. FIG. 12 is a schematic diagram (a box 1202 shown in FIG. 12) of the extracted rail middle section image after processing by the region-of-interest extraction module 1001, and the rail middle section image clearly contains the rail and the regions on two side of the rail. In addition, the size of the rail middle section image is about one half of that of the rail region image (a box 1201 shown in FIG. 12).

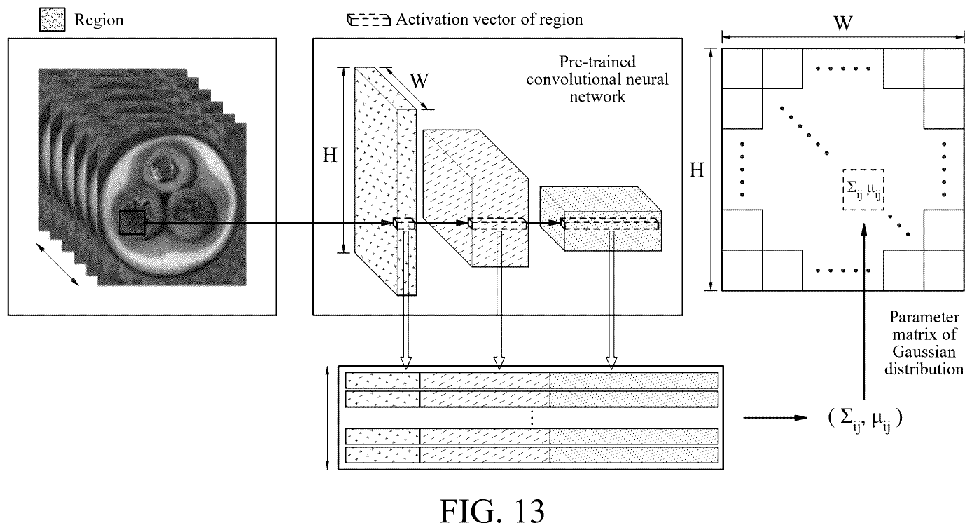

Please refer to FIG. 13, FIG. 13 is a schematic diagram of an anomaly detection module 1002 according to an embodiment of the present disclosure. As shown in FIG. 13, in PaDiM, a convolutional neural network (CNN) is used for extracting the characteristics of the image data, and the characteristics are divided into a plurality of small patches. The characteristics of the patches are used for establishing a Gaussian distribution model. The principle of PaDiM anomaly detection is to compare each pixel of two pictures to determine whether the two pictures belong to the same category, and as long as only normal pictures are placed during training, the model can regard the pictures without the characteristics of the normal pictures as abnormal pictures. The inputted pictures will be divided into a plurality of patches according to a specific height (H) and a specific width (W), then characteristics will be extracted through the pre-trained CNN, and the characteristics of different levels are combined, and then Gaussian distribution parameters of each patch is computed by using the combined characteristics. In deduction, it is only needed to compute mahalanobis distance between each pixel on the pictures to be detected and the corresponding Gaussian distribution, and then an anomaly score is obtained, the higher the anomaly score is, the farther the pixel is from the trained Gaussian distribution of the normal pictures, and the more possible the pixel is abnormal. The Gaussian distribution is generally described by two parameters including a covariance matrix (Σ_{i,j}) and a mean vector (μ_{i,j}), and the two parameters jointly define the shape and the position of the Gaussian distribution. The mean vector (μ_{i,j}) represents the central position of the data, which indicates the mean value of the data; and the covariance matrix (Σ_{i, j}) represents the dispersion degree of the data and the correlation between dimensions. The covariance matrix is symmetrical, diagonal elements represent variation of each dimension, and non-diagonal elements represent covariance between different dimensions. In one embodiment, a determination threshold value can be set, a part exceeding the threshold value can be determined to be an abnormal object, and this method can be used for detecting any abnormal part. In one embodiment, the threshold value can be set or adjusted according to an actual application scene, so that mis-determination can be reduced, or the accuracy can be improved, and in a preferred embodiment, the threshold value is 0.5.

Please refer to FIG. 14, FIG. 14 is a schematic diagram of abnormal characteristics detected by an anomaly detection module 1002 according to an embodiment of the present disclosure. FIG. 14 shows the abnormal characteristics detected after the anomaly detection module 1002 processes the middle section image, and a circled area 1401 shown in FIG. 14 marks the position of the abnormal object.

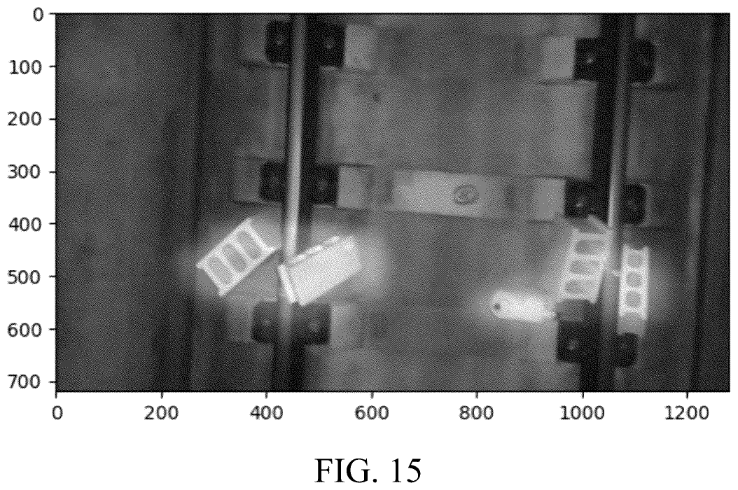

Please refer to FIG. 15, FIG. 15 is a schematic diagram of marks of abnormal characteristics according to an embodiment of the present disclosure. FIG. 15 shows the marks generated by the detection module 302 on image data 210 with the abnormal characteristics based on the prediction output of the anomaly detection module 1002 (shown in FIG. 15). For example, the anomaly detection module 1002 infers that the image data 210 may obtain the anomaly score, and the detection module 302 can add the marks on regions with high anomaly score. The marks can be colors, characters or symbols. In one embodiment, the marks can be marked on the image data 210 in different colors, or in different color levels of the same color according to the abnormal scores. The deeper the color level is, the more likely the abnormal object is. However, the picture marked in the color level looks different from the actual scene, so that the detection module 302 can utilize a visual method of adding a color graphic box (such as a rectangular box or a circular box) to the abnormal object on the original picture, and the abnormal object is boxed as much as possible to facilitate the user to check.

What is claimed is:

1. An abnormal object detection warning system, being applicable to image data captured by an unmanned vehicle performing a track inspection task, comprising:
a detection module configured to detect the image data to identify image data with abnormal characteristics from the image data; and
a notification module configured to transmit a warning signal with the abnormal characteristics.

2. The abnormal object detection warning system according to claim 1, wherein the detection module comprises a neural network module configured to receive the image data and process the image data through a neural network so as to obtain a prediction output; and the detection module generates a mark on the image data with the abnormal characteristics based on the prediction output.

3. The abnormal object detection warning system according to claim 2, wherein the abnormal characteristics comprise a bent rail.

4. The abnormal object detection warning system according to claim 3, wherein the neural network module comprises an object detection module configured to detect a rail region in the image data so as to obtain a rail region image.

5. The abnormal object detection warning system according to claim 4, wherein the neural network module comprises an image segmentation module configured to remove a non-rail background image in the rail region image so as to obtain a rail boundary image.

6. The abnormal object detection warning system according to claim 5, wherein the detection module comprises:
a rail boundary processing module configured to process the rail boundary image so as to obtain a rail boundary, and segment the rail boundary into a plurality of sections;
a linear regression processing module configured to perform linear regression on each section in the plurality of sections so as to obtain slopes of the plurality of sections, and compute a mean slope of the plurality of sections; and
a rail anomaly determination module configured to compute a determination value based on the section slope and the mean slope, and determine whether the rail is bent according to the determination value.

7. The abnormal object detection warning system according to claim 4, wherein the object detection module comprises:
a backbone network layer configured to extract a plurality of scale characteristics from the image data;
a neck layer connected to the backbone network layer and configured to combine the plurality of scale characteristics to improve abilities of detecting objects of various sizes; and
a detection head layer connected to the neck layer and configured to predict bounding boxes and category of the objects based on the plurality of combined scale characteristics; and
the backbone network layer is a cross stage partial darknet (CSPDarknet), the neck layer is a combination of a spatial pyramid pooling (SPP) and a path aggregation network (PAN), and the detection head layer is a YOLO detection head (YOLO-Head).

8. The abnormal object detection warning system according to claim 7, wherein the detection module comprises a region-of-interest extraction module configured to extract a rail middle section image from the rail region image.

9. The abnormal object detection warning system according to claim 8, wherein the neural network module comprises an anomaly detection module configured to detect abnormal characteristics of the rail middle section image, and the abnormal characteristics contain foreign objects on a railway.

10. The abnormal object detection warning system according to claim 1, further comprising a storage module configured to store the image data captured by the unmanned vehicle.

11. An abnormal object detection method, comprising:
(a) storing image data captured by an unmanned vehicle through a storage module;
(b) detecting the image data by a detection module so as to identify image data with abnormal characteristics from the image data; and
(c) transmitting the image data with the abnormal characteristics to a mobile device of a user through a notification module.

12. The abnormal object detection method according to claim 11, wherein the detection module comprises a neural network module; and step (b) comprises: (d) receiving the image data by the neural network module, and processing the image data through a neural network so as to obtain a prediction output; and (e) generating a mark on the image data with the abnormal characteristics based on the prediction output by the detection module.

13. The abnormal object detection method according to claim 12, wherein the abnormal characteristics comprise a bent rail.

14. The abnormal object detection method according to claim 13, wherein the neural network module comprises an object detection module, and step (b) comprises: (b1) detecting a rail region in the image data by the object detection module so as to obtain a rail region image.

15. The abnormal object detection method according to claim 14, wherein the neural network module comprises an image segmentation module; and step (b) comprises: (b2) removing a non-rail background image in the rail region image by the image segmentation module so as to obtain a rail boundary image.

16. The abnormal object detection method according to claim 15, wherein step (b) comprises:
(b3) processing the rail boundary image by a rail boundary processing module so as to obtain a rail boundary, and segmenting the rail boundary into a plurality of sections;
(b4) performing linear regression on each section in the plurality of sections by a linear regression processing module so as to obtain slopes of the plurality of sections, and computing a mean slope of the plurality of sections; and
(b5) computing a determination value based on the section slope and the mean slope by a rail anomaly determination module, and determining whether the rail is bent according to the determination value.

17. The abnormal object detection method according to claim 14, wherein a neural network architecture of the object detection module comprises a backbone network layer, a neck layer and a detection head layer; the neck layer is connected to the backbone network layer, and the detection head layer is connected to the neck layer; step (d) comprises:
(d1) extracting a plurality of scale characteristics from the image data by the backbone network layer;
(d2) combining the plurality of scale characteristics by the neck layer to improve abilities of detecting objects of various sizes; and
(d3) predicting bounding boxes and category of the objects based on the plurality of combined scale characteristics by the detection head layer; and
the backbone network layer is a cross stage partial darknet (CSPDarknet), the neck layer is a combination of a spatial pyramid pooling (SPP) and a path aggregation network (PAN), and the detection head layer is a YOLO Detection Head (YOLO-Head).

18. The abnormal object detection method according to claim 17, wherein the detection module comprises a region-of-interest extraction module; and step (b) comprises: (b6) extracting a rail middle section image from the rail region image by the region-of-interest extraction module.

19. The abnormal object detection method according to claim 18, wherein the neural network module comprises an anomaly detection module; step (b) comprises: (b7) detecting abnormal characteristics of the rail middle section image by the anomaly detection module; the anomaly detection module is a patch distribution modeling (PaDiM); and the abnormal characteristics contain foreign objects on a railway.

20. An electronic device, comprising:
a storage unit configured to store image data captured by an unmanned vehicle;
a memory unit configured to store system software for the electronic device to execute, the system software comprising:
a detection module configured to detect the image data to identify image data with abnormal characteristics from the image data, wherein the detection module comprises a neural network module configured to receive the image data and process the image data through a neural network so as to obtain a prediction output, and the detection module generates a color on the image data with the abnormal characteristics based on the prediction output; and
a network unit configured to transmit the image data with the abnormal characteristics, wherein
the electronic device updates the system software online through the network unit.
